(19) United States
(12) Patent Application Publication
(10) Pub. No.: US 2023/0210137 A1
(43) Pub. Date: Jul. 6, 2023

(54) Composition and Delivery Method of an Animal Nutritional Supplement

(71) Applicant: GENHOVATION LLC, Preston, ID (US)

(72) Inventor: Daniel Genho, Preston, ID (US)

(73) Assignee: GENHOVATION LLC, Preston, ID (US)

(21) Appl. No.: 18/092,156

(22) Filed: Dec. 30, 2022

Related U.S. Application Data
(60) Provisional application No. 63/295,252, filed on Dec. 30, 2021.

(51) Int. Cl. A23K 10/30; A23K 20/163

(52) U.S. Cl. CPC A23K 10/30; A23K 20/163

(57) ABSTRACT

Disclosed herein is a composition of one or more nutritional supplements. The composition may include a relaxant, an emulsifying agent, and a palatability enhancer. In another embodiment is disclosed a composition of relaxant, palatability enhancer, and adhesive. Further disclosed, are various methods of delivery of one or more nutritional supplements to the animal through water and feed.

### TECHNICAL FIELD

The disclosure relates generally to a composition of one or more nutritional supplements and a method of delivery of one or more nutritional supplements to an animal. This facilitates stress management practices by providing to an animal the one or more nutritional supplements which include a relaxant.

### BACKGROUND

Humans and animals have interacted for centuries, and both have benefited from a synergistic relationship. Domestication of animals began with the domestication of a wolf around 15,000 years ago. Approximately 4,000 years later, livestock began to be domesticated starting with sheep and goats. Afterward, the domestication of many other animals followed (e.g., cats, chickens, pigs, cattle, donkeys, camels, horses, water buffalos, reindeer, llamas, alpacas, and turkeys). Domesticated animals, as a result, have become ubiquitous in our society and are used in a variety of different roles (e.g., companionship, therapy, hunting, law enforcement, gaming, entertainment, religion, work, search and rescue, protection, food, and clothing). Much of the food consumed in the world comes from animals such as milk products, eggs, lard, and meat (e.g., pork, beef, lamb, chicken, turkey, and bacon). Additionally, animals provide a variety of non-food products including leather, wool, cashmere, mohair, cosmetics, medicine, and scientific research. Animals have also been used for work (e.g., therapy, ranching, horseback riding, hunting, backpacking, rodeo, gambling, and sports). Horses alone account for many equestrian-related sports beyond rodeo including dressage, endurance riding, eventing, reining, show jumping, tent pegging, vaulting, horse racing, polo, and cutting.

Because of this interdependence between humans and animals, maintaining appropriate levels of stress may have a large impact on both animals and humans. Many if not all human-animal interactions are affected by animal stress. Because of this interdependency between humans and animals, maintaining appropriate levels of stress for the animals may be helpful. Stress in animals can lead to a weakened immune system, weight/muscle loss, appetite loss, digestive problems, poor work/sports performance, decreased wool/fur production and quality, decreased egg production, heart problems, reduced consumption, reduced fertility, decreased meat quality, and more. This is often linked to the excess levels of cortisol found in the animal due to stress.

Stress in animals can manifest in a variety of different ways but is often related to fear. Fear is an evolutionary tool developed through the ages to avoid predators. Fear increases the cortisol levels in an animal. Furthermore, fear can also be conditioned in animals by humans. For animals with continuous interaction with humans, such as pets, much fear can be eliminated through positive animal-human interactions.

There have been a variety of different techniques to calm animals. For example, going for a walk, playing with, grooming, or just spending time with a pet are ways to lower the pet's stress level. Additionally, there is massage therapy, aroma therapy, and acupuncture for animals. There is even clothing that a pet can wear that is meant to calm the animal.

With livestock there often is not enough time or resources to be able to allocate animal-human interactions for exclusively calming purposes. Further, it is likely cost-prohibitive to provide massage therapy, aroma therapy, acupuncture, and calming clothing for livestock. A possible solution for livestock might be to try to limit animal-human interactions. If animal-human interactions are unavoidable it may be helpful to make the animal-human interaction as stress-free as possible by not yelling, scaring, or causing pain to the animal. Some sources of pain may be unavoidable such as vaccines, branding, pregnancy checking, dehorning, birth assistance, tagging, roping, tranquilizing, castration, shearing, etc. Even in instances where causing pain is avoidable, an animal may still feel stress because of external sources (e.g., a predator, fireworks, storms, vehicles, gunshots, other animals, injuries, illness, etc.).

For centuries, people in the pacific islands have used the kava plant to reduce anxiety while maintaining cognitive abilities. Kava is a pepper plant originating in New Guinea and/or Vanuatu which eventually spread to the pacific islands including the islands of Polynesia, Micronesia, and Melanesia. The resin found in the root of the Kava plant is consumed medicinally, ceremonially, and socially for its sedative effect. Known under several names, such as awa, ava, yaquone, sakau, kava kava, malak, and malague, kava has been used for generations. The active ingredient in the kava resin is pyrone derivatives called kavalactones which produce a sedative, anesthetic, and euphoric effect on the user. Of the eighteen kavalactones found in kava, six kavalactones make up the majority of the kavalactones found in kava resin e.g., methysticin, dihydromethysticin, kavain, dihydrokavain, yangonin, and desmethoxyyangonin.

Kava is grouped into two types of kava, noble kava, and tudei (or two-day) kava. Tudei kava comes from a wild kava plant (piper wichmanii) ancestor of the domesticated type. In comparison to noble kava, tudei kava has different ratios of kavalactones. For instance, the concentration of dihydromethysticin is greater in concentration in the tudei kava than in the noble kava.

The object of this disclosure is to utilize a relaxant that may include other additives in such a way as to create one or more nutritional supplements that may help alleviate stress in animals. Another object of this disclosure is to provide a method of administering one or more nutritional supplements containing the relaxant to one or more animals.

### SUMMARY

Disclosed herein is a composition of one or more nutritional supplements. The compositions include a relaxant and may further include one or more of an emulsifiers, an adhesive, and a palatability enhancer. Further disclosed, are various methods of delivery of the one or more nutritional supplements to the animal through water and/or feed.

### BRIEF DESCRIPTION OF THE DRAWINGS

Non-limiting and non-exhaustive implementations of the present disclosure are described with reference to the following figures, wherein the same or similar reference numerals generally refer to the same or similar parts throughout the various views unless otherwise specified. The advantages of the present disclosure will become better understood with regard to the following description and accompanying drawings:

FIG. 1 illustrates an exemplary percentage allocation of an animal nutritional supplement for a water application.

FIG. 2 illustrates an exemplary percentage allocation of an animal nutritional supplement for a feed application.

FIG. 3 illustrates an exemplary flowchart for a method of administering a nutritional supplement to an animal through water due to a scheduled stressor.

FIG. 4 illustrates an exemplary flowchart for a method of administering a nutritional supplement to an animal through feed due to a scheduled stressor.

FIG. 5 illustrates an exemplary flowchart for a method of administering a nutritional supplement to an animal through water due to an unscheduled stressor.

FIG. 6 illustrates an exemplary flowchart for a method of administering a nutritional supplement to an animal through feed due to an unscheduled stressor.

### DETAILED DESCRIPTION

In the following description, for purposes of explanation and not limitation, specific techniques and embodiments are set forth, such as particular techniques and configurations, in order to provide a thorough understanding of the compositions and methods disclosed herein. While the techniques and embodiments will primarily be described in context with the accompanying drawings, those skilled in the art will further appreciate that the techniques and embodiments may also be practiced in other similar methods.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

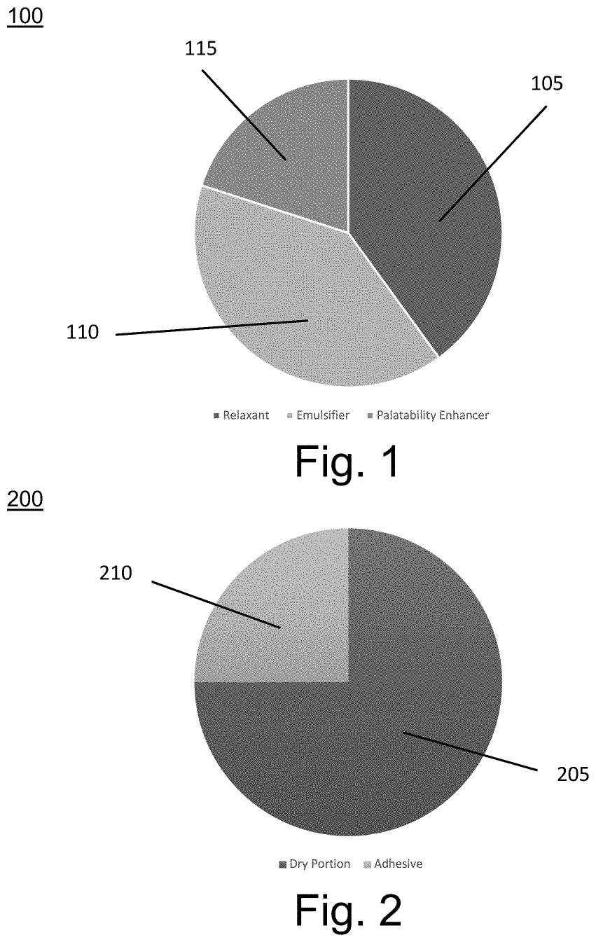

FIG. 1 illustrates an exemplary percentage allocation of the animal nutritional supplement 100 for a water application. Animal nutritional supplement 100 may be used to lower cortisol levels in the target animal. Animal nutritional supplement 100 may include relaxant 105. Relaxant 105 may be comprised of but is not limited to withania somnifera (“ashwagandha”) and/or kavalactones similar to those found in the kava plant of either the tudei and/or noble varieties. Relaxant 105 may be comprised of but is not limited to processed and unprocessed vitamins, minerals, plants, fungi, and/or herbs and their derivatives. Relaxant 105 may be used to lower cortisol levels within the animals. Relaxant 105 can be included in the nutritional supplement 100 in many forms. For example, relaxant 105 may be a part of an extract from the plant (e.g., kava or ashwagandha) in a powder, in a tincture, and may include one or more of kavalactones and withanolides that have been synthesized. In other words, relaxant 105 may include any one or more of the following: ingredients naturally found in a plant or commonly found in powdered extract; ingredients found in a tincture such as alcohol; ingredients used to synthesize the relaxant. FIG. 1 illustrates an exemplary embodiment of an allocation of nutritional supplement 100 where the relaxant 105 makes up 40% by weight of the nutritional supplement 100. The allocation of relaxant 105 may range from 40-72% by weight of the nutritional supplement 100.

Nutritional supplement 100 may be effective after consumption by the animal. Many animals have an enhanced sense of smell and taste and avoid unpalatable foods. Furthermore, kava and ashwagandha, if used in relaxant 105, are often considered bitter and may require at least a small amount of palatability enhancer 115 to aid in the consumption of nutritional supplement 100 by a target animal. Palatability enhancer 115 may include natural and/or artificial flavorings (e.g., dextrose, fructose, saccharin, sucralose, glucose, maltose, and lactose). In addition to or in place of natural and artificial sweeteners, palatability enhancer 115 may also include vitamins, minerals, fruit flavoring, citric acid, fenugreek, coconut oil, soybean oil, and/or other oils, molasses, cinnamon, barley and/or other grains, talin and/or other proteins, electrolytes, flavonoids, and/or other natural or artificial flavorings. The allocation of palatability enhancers 115 ranges from 4-20% by weight of the nutritional supplement 100. The chart in FIG. 1 is an exemplary embodiment of an allocation of nutritional supplement 100 where the palatability enhancers 115 make up 20% by weight of the nutritional supplement 100.

Nutritional supplement 100 may further include emulsifier 110 which is used to suspend hydrophobic molecules into a liquid solution. Some relaxants 105 may include one or more of ashwagandha and kavalactones. Some kavalactones and portions of ashwagandha are hydrophobic (fat-soluble) and may benefit from an emulsifier 110 to suspend hydrophobic portions of relaxant 105 in solution. In this embodiment, the emulsifier 110 to relaxant 105 (e.g., extract, tincture, and/or synthesis) ratio may be from 1:1 to 1:4. To that end, the nutritional supplement 100 may include emulsifier 110 at a range between 28-40% by weight of nutritional supplement 100. The chart in FIG. 1 is an exemplary embodiment of an allocation of nutritional supplement 100 where the emulsifier 110 makes up 40% by weight of nutritional supplement 100.

FIG. 2 illustrates an exemplary percentage allocation of animal nutritional supplement 200 for a feed application. Nutritional supplement 200 may be used to lower cortisol levels in the target animal. Nutritional supplement 200 may contain dry portion 205 of nutritional supplement 200. Dry portion 205 may include relaxant 105 in a dry form and may include palatability enhancers 115 in a dry form. Nutritional supplement 200 may further include adhesive 210 which may include the non-dry portion of nutritional supplement 200. Adhesive 210 may help nutritional supplement 200 to attach to the feed to aid in the ingestion of nutritional supplement 200. Adhesive 210 in an alternative embodiment may be included to create a paste that may be orally or rectally injected into the animal. Furthermore, adhesive 210 may also be used to create a pill that may be administered to the animal orally or rectally. If administering the nutritional supplement in a pill form, the dry supplement may be placed into a capsule. Adhesive 210 of nutritional supplement 200 may include relaxant 105 in a liquid (e.g., tincture or in a liquid solution of relaxant 105 which may include emulsifier 110) and/or liquid palatability enhancers 115 (e.g., molasses, oils, dextrose, fructose, saccharin, sucralose, glucose, maltose, lactose, fruit extracts, liquid vitamins, etc.). In an alternative embodiment, nutritional supplement 100 may be used interchangeably with nutritional supplement 200 as long as the non-dry portion of supplement 100 acts as adhesive 210.

In practice, nutritional supplement 200 (as with nutritional supplement 100) may be administered with the amount of relaxant 105 being 0.1 mg to 2 mg per 1 kg of animal weight per day. The amount of relaxant 105 prescribed for an animal can range from 0.1 mg to 2 mg per 1 kg of animal weight per day. For example, a one-year-old horse weighing 228 kg at 1 mg per 1 kg would require 228 mg of relaxant 105 per day. Palatability enhancer 115 may range from 5.5% to 50% of the amount of relaxant 105. Assuming the horse is a selective eater, 114 mg of a dry palatability enhancer 115 may be used (50% of relaxant 105). In one embodiment, a 1:3 ratio of adhesive 210 to dry portion 205 may be used. Thus, for nutritional supplement 200 having a total dry portion 205 of 342 mg (228 mg of relaxant plus 114 mg of palatability enhancer 115) the amount of adhesive 210 would be 114 mg. Therefore, the total amount of nutritional supplement 200 that may be mixed with the feed would be 456 mg per day for the 228 kg horse.

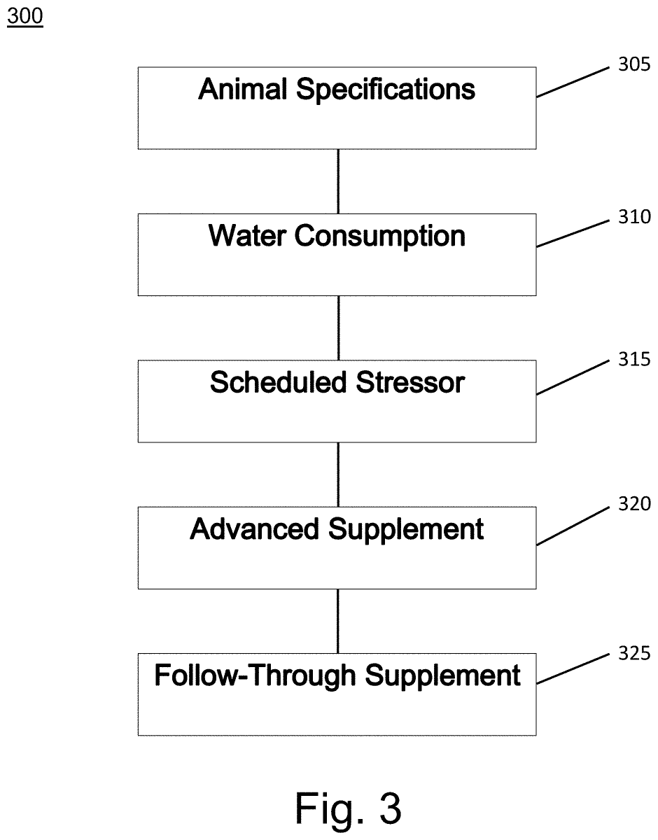

FIG. 3 illustrates an exemplary flowchart for method 300 of administering nutritional supplement 100 to an animal through drinking water due to scheduled stressor performance 315. Method 300 may be completed in any order and may include one or more steps in method 300 and may further be combined with one or more steps found in another method. Accordingly, the order provided is exemplary. Initially, an administrator may determine the animal specification 305. Each type of animal may have a different reaction to nutritional supplement 100. For example, cattle have a ruminant digestive system that includes a four-part stomach while pigs have a monogastric system. Each digestive system may absorb relaxant 105 differently and therefore it may be helpful to first determine or identify the type of animal. Further, the type of breed may help determine the behavior of the animal and its propensity to absorb nutritional supplement 100. Also, some animals are more selective eaters than others. For example, a panda bear survives almost entirely on eating bamboo while a raccoon will eat almost any food found in a garbage can. As a result, a panda bear may need a substantial amount of bamboo-flavored palatability enhancer 115 while a raccoon may require very little palatability enhancer 115.

A variety of factors may be used to determine water consumption 310. First, it may be helpful to determine the age of an animal and weight to help establish the volume of water to be consumed. Diet may also affect water consumption of the animal. For example, if the feed given to the animal is high in protein and/or salt, water consumption may increase. Furthermore, the surrounding environment will also help indicate water consumption of the animal. In hotter temperatures, animals tend to consume more water and the opposite is true in colder temperatures. Water consumption may also be observed by a machine or by determining how often a water tank is filled. Determining what type of trough, bowl, cup, or nipple drinking system is used may be helpful because some animals' water consumption may vary depending on the drinking system used. For example, a pig using a nipple drinker may have a higher volume of water consumption than if the pig were to be provided water in a trough.

Often the provider may schedule certain events for their animal that are considered scheduled stressor performance 315. Exemplary stressors are events that may solicit anxiety or stress in an animal which raises the animal's cortisol levels. A scheduled stressor is an event that may solicit anxiety or stress in an animal at a particular time or on a particular date at a particular time. Exemplary scheduled stressor performance 315 may include administering a vaccine to a dog, neutering a cat scheduled, weaning piglets, shipping cattle to a feedlot, shearing sheep, and a host of other stressors. Often the stress induced by scheduled stressor performance 315 may be lessened through administering nutritional supplement 100.

Upon determining the animal specifications 305 and determining water consumption 310, an amount of nutritional supplement 100 may be determined. Generally, nutritional supplement 100 may be administered with the amount of relaxant 105 being 1 mg per 1 kg of animal weight per day. The amount of relaxant 105 prescribed for an animal can range from 0.5 to 1.5 mg per 1 kg of animal weight per day. Further, the amount of palatability enhancer 115 may be 5.5% to 50% as compared to relaxant 105. Emulsifier 110 may be included in the nutritional supplement from 33% to 100% of the amount of relaxant 105. For example, animal specifications include a weaned pig weighing 14 kg and consuming 1.5 gallons of water a day. Nutritional supplement 100 would include 14 mg of relaxant 105, 14 mg of emulsifier 110, and 7 mg of palatability enhancer 115. Nutritional supplement 100 may then be placed in an aqueous solution. The provider may determine the volume of water found in the watering container and, depending on the expected water consumption, the amount of nutritional supplement 100 to be added may be determined. Administering nutritional supplement 100 may be done manually or using a water medicator. A water medicator may allow nutritional supplement 100 to be placed into the medicator and then the medicator may automatically distribute the proper amount of nutritional supplement 100 into the water. Administration of advanced supplementation 320 provides nutritional supplement 100 at any time prior to scheduled stressor performance 315. Optimally nutritional supplement 100 is provided to the animal between two days to nine hours before scheduled stressor performance 315.

The impact of scheduled stressor performance 315 can continue to affect the animal beyond the occurrence of scheduled stressor performance 315. To help alleviate the negative impact of scheduled stressor performance 315, follow-through supplementation 325 may provide nutritional supplement 100 to the animal. The calming that nutritional supplement 100 may provide allows the animal to resolve the negative impact of stress. Follow-through supplementation 325 may be administered after scheduled stressor performance 315 has occurred. Ideally, nutritional supplement 100 is provided to the animal for a duration of 1-7 days after scheduled stressor performance 315. The duration that nutritional supplement 100 is provided to the animal may be adjusted depending on the type and severity of scheduled stressor performance 315 and the stress sensitivity of the animal. For example, if scheduled stressor performance 315 included displacing a pig while cleaning out a pig pen, the duration of follow-through supplementation 325 may last 1 day. Alternatively, if a young pig is removed from his mother during weaning, this scheduled stressor performance 315 may necessitate follow-through supplementation 325 for 7 days.

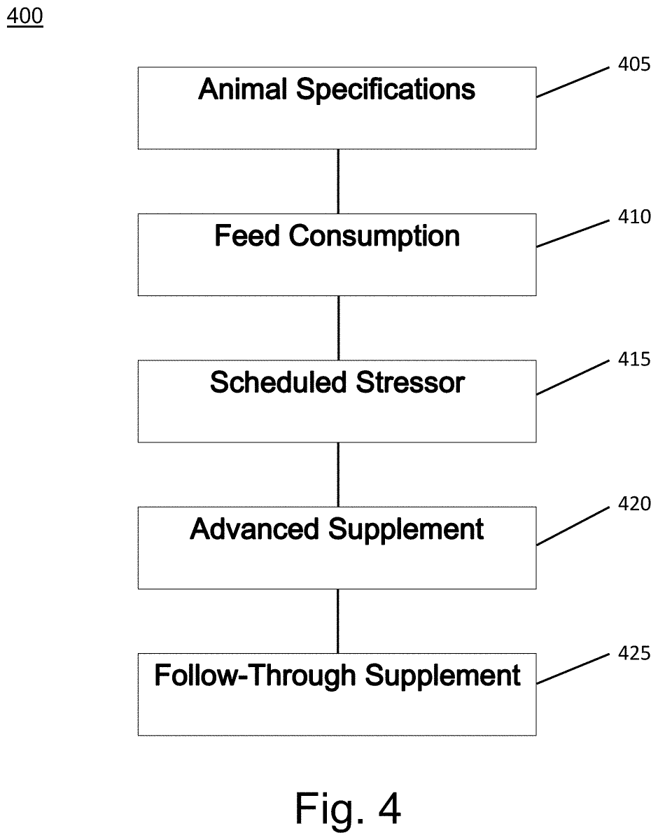

FIG. 4 illustrates an exemplary flowchart for method 400 of administering the nutritional supplement to an animal through feed due to scheduled stressor performance 415. Method 400 may be completed in any order and may include one or more steps in method 400 and may further be combined with one or more steps found in another method. Method 400 includes determining or identifying the animal specifications 405. Initially, an administrator may determine the animal specification 405 in part because each type of animal may have a different reaction to nutritional supplement 200. Since, for example, cattle have ruminant digestive systems that include a four-part stomach while pigs have monogastric systems each system may absorb relaxant 105 differently. Further, the type of breed or age of the animal may help determine what type of palatability enhancers 115 would be helpful in the consumption of the nutritional supplement 200. Furthermore, some animals are more selective in their diet than others. For example, a panda bear survives almost entirely on eating bamboo while a raccoon will find and eat rotten fruit out of a garbage can. As a result, a panda bear may need a substantial amount of bamboo-flavored palatability enhancer 115 while a raccoon may require very little palatability enhancer 115.

Determining animal specifications 405 may help to establish how much feed consumption 410 will occur. Also, concerning feed consumption 410, determining the surrounding environment may help determine feed consumption 410. As a result, feed consumption 410 may be altered depending on how hot or cold the temperature is. Further indications of feed consumption 410 include the type of feed provided. The amount of feed consumption 410 may be distinct if cattle are given mineral supplements as compared to sweet feed. Mineral supplements generally contain a selective amount of salt to help regulate animal feed consumption 410 and therefore fewer mineral supplements than sweet feed are likely to be consumed by the cattle. As a result, the amount or concentration of nutritional supplement 200 placed on sweet feed would be less than what was placed on mineral supplement because sweet feed is likely consumed at a higher rate than a mineral supplement. Stressors also have been known to affect feed consumption 410 and may be taken into consideration. Alternatively, if nutritional supplement 210 is being used to create a paste or a pill feed, consumption 410 may be omitted.

Owners may know of and have a scheduled stressor 415. For example, exemplary stressors are events that may solicit anxiety or stress in an animal. A scheduled stressor is an event that may solicit anxiety or stress in an animal at a particular time or on a particular date at a particular time. Exemplary scheduled stressors 415 may include a dog scheduled for a haircut, a cat scheduled to get neutered, piglets scheduled to be weaned, cattle scheduled to be shipped to a feedlot, and sheep scheduled to be sheared. The effects of one or more scheduled stressors 415 may be lessened through administering nutritional supplement 200.

Once scheduled stressor 415 has been determined, advanced supplement 420 of nutritional supplement 200 may be administered to the animal. Nutritional supplement 200 may be administered in step 420 as an advanced supplement to help relax the animal for an upcoming scheduled stressor. Advanced supplement 420 may include placing nutritional supplement 200 into the feed of an animal. Upon determining the animal specifications 405 an amount of nutritional supplement 200 may be determined.

In practice, nutritional supplement 200 (as with nutritional supplement 100) may be administered with the amount of relaxant 105 being 1 mg per 1 kg of animal weight per day. The amount of relaxant 105 prescribed for an animal can range from 0.5 to 1.5 mg per 1 kg of animal weight per day. For example, animal specifications 405 may include a weaned pig weighing 24 kg whereas the pig may have a feed consumption 410 of 1 kg a day. The pig would require 1 mg of relaxant 105 per 1 kg of animal weight per day which would amount to 24 mg of relaxant per day. Palatability enhancer 115 can range from 5.5% to 50% to the amount of relaxant 105. Assuming the pig is a selective eater 12 mg of a dry palatability enhancer 115 (50% of relaxant 105). There is generally a ratio of 1:3 of dry portion 205 to adhesive 210. The total dry portion 205 of nutritional supplement 200 in this embodiment would be 36 mg and at a 1:3 ratio, the amount of adhesive 210 would be 12 mg. The range of adhesive 210 may be between 5-25% of the nutritional supplement 200. The total amount of nutritional supplement 200 to be mixed with feed would be 48 mg per day for the pig weighing 24 kg. Nutritional supplement 200 may be mixed manually or may be premixed using a machine before packaging.

Advanced supplement 420 is set up to provide the nutritional supplement 200 at any time prior to scheduled stressor 415. Optimally nutritional supplement 200 is provided to the animal between two days to nine hours before scheduled stressor 415. The impact of scheduled stressor 415 can continue to affect the animal beyond the moment scheduled stressor 415 occurred. To help alleviate the negative impact of scheduled stressor 415 follow-through supplement 425 may be provided to the animal. The calming that nutritional supplement 200 may provide may allow the animal to leave behind the negative impact of scheduled stressor 415 more quickly. Follow-through supplement 425 may include nutritional supplement 200 given to the animal after scheduled stressor 415 has occurred. A different combination of nutritional supplement 200 may be used for follow-through supplement 425 than was used for the advanced supplement 420. Ideally, nutritional supplement 200 is provided to the animal for a duration of one to seven days after the scheduled stressor 415. The duration of follow-through supplement 425 of nutritional supplement 200 may be adjusted depending on the type of scheduled stressor 415. For example, if scheduled stressor 415 included displacing a pig while cleaning out the pig pen, the duration of nutritional supplement 200 may be less than if scheduled stressor 415 included the weaning of the pig.

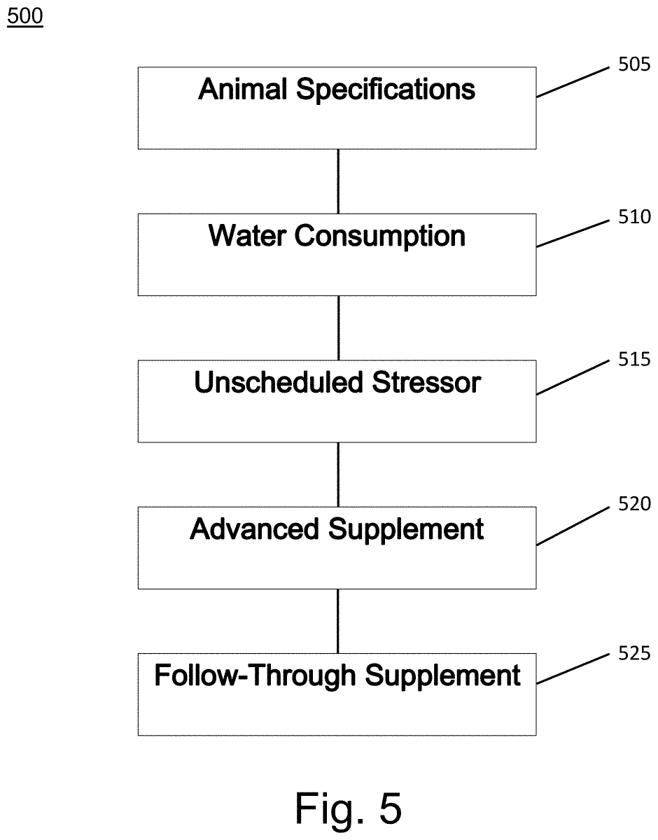

FIG. 5 illustrates an exemplary flowchart for method 500 of administering nutritional supplement 100 through water to an animal as a preventative measure for unscheduled stressor events. Method 500 may be completed in any order and may include one or more steps in method 500 and may further be combined with one or more steps found in another method disclosed herein. A user may first determine the animal specification 505 starting with what type of animal is to be prescribed nutritional supplement 100. Each type of animal may have a different reaction to nutritional supplement 100. For example, cattle have a ruminant digestive system that includes a four-part stomach while pigs have a monogastric system that includes a single stomach. Each digestive system may absorb relaxant 105 differently and therefore it may be helpful to first determine the type of animal. Further, the type of breed may help determine the behavior of the animal and its propensity to absorb nutritional supplement 100. Also, some animals are more selective eaters than others. For example, a panda bear survives almost entirely on eating bamboo while a raccoon will eat almost any food found in a garbage can. As a result, a panda bear may need a bamboo-flavored palatability enhancer 115 while a raccoon may require very little palatability enhancer 115. Secondly, it may be helpful to determine the pigs' age and weight to establish how much water intake is likely to occur. Also, concerning water consumption 510, it may be helpful to determine if the feed given to the animal is high in protein and/or salt for this may increase the volume of water consumption 510 of the animal. The surrounding environment will also help indicate water consumption 510 of the animal.

Animal specification 505 determined in the previous step will help give the administrator an idea of the volume of water consumption 510 of the animal. This volume of water consumed 510 may be determined through observation, by a machine, or by determining how often a water tank runs dry. Also, it may be helpful to determine what type of drinking system is used to provide water e.g., a trough, a bowl, a cup, or a nipple drinking system. For example, a pig using a nipple drinker may drink more water than if the pig is provided water in a trough. After determining water consumption 510 of the animal the provider may further determine the amount of nutritional supplement 100 to add to the water.

The frequency and duration of unscheduled stressor 515 may be unknown. In one example, an unscheduled stressor may be a cow encountering a predator animal. Method 500 is intended to provide for the animal in one of two ways; first, advanced supplement 520 may be given in preparation for an unknown stressor without a definite ending time. Advance supplement 520 may be provided to the animal in preparation for an unscheduled stressor 515 (e.g., a wolf has been sighted in an area, for example) and then followed by follow-through supplement 525 after the occurrence of unscheduled stressor 525 (e.g., a wolf attacks at night before it is captured several days later). The ratios of nutritional supplement 100 may be different for the advanced supplement 520 as compared to the follow-through supplement 525. In an alternative embodiment, advanced supplement 520 may be omitted and follow-through supplement 525 of nutritional supplement 100 be provided after unscheduled stressor 515 occurs.

Upon determining the animal specifications 505 an amount of nutritional supplement 100 may be determined. Generally, nutritional supplement 100 may be administered with the amount of relaxant 105 being 1 mg per 1 kg of animal weight per day. The amount of relaxant 105 prescribed for an animal can range from 0.5 to 1.5 mg per 1 kg of animal weight per day. Further, the amount of palatability enhancer 115 may consist of 5.5% to 50% to that of relaxant 105. Emulsifier 110 may exist in the nutritional supplement from 33% to 100% to that of relaxant 105. For example, animal specifications 505 include a weaned pig weighing 14 kg consuming 1.5 gallons of water a day. Nutritional supplement 100 would include 14 mg of relaxant 105, 14 mg of emulsifier 110, and 7 mg of palatability enhancer 115. Nutritional supplement 100 may then be placed in an aqueous solution.

The provider may determine the volume of water found in the container and depending on the water consumption 510 an amount of nutritional supplement 100 to be administered may be determined. Adding nutritional supplement 100 may be done manually or using a water medicator. A water medicator may allow nutritional supplement 100 to be placed into the medicator and then the medicator may automatically distribute the proper amounts of nutritional supplement 100. Adding nutritional supplement 100 may be done manually or nutritional supplement 100 may be placed into the medicator and then the medicator may automatically distribute nutritional supplement 100. Advanced supplement 520 is set up to provide nutritional supplement 100 at any time prior to unscheduled stressor 515. Optimally nutritional supplement 100 is provided to the animal between two days to nine hours before unscheduled stressor 515.

The impact of unscheduled stressor 515 can continue to affect the animal beyond the moment unscheduled stressor 515 occurs. To help alleviate the negative impact of unscheduled stressor 515 follow-through supplement 525 may be provided to the animal. The calming that nutritional supplement 100 may provide allows the animal to resolve the negative impact of stress more quickly. Follow-through supplement 525 may be any nutritional supplement 100 given to the animal after unscheduled stressor 515 has occurred. Ideally, nutritional supplement 100 may be provided to the animal for 1-7 days after the unscheduled stressor 515. The duration of follow-through supplement 525 of nutritional supplement 100 may be adjusted depending on the type of unscheduled stressor 515. Other adjustments that may occur may be the concentration of different ingredients such as relaxant 105 in nutritional supplement 100. For example, if unscheduled stressor 515 included displacing a pig while cleaning out the pig pen because of an unexpected storm the duration of nutritional supplement 100 may be less than if the unscheduled stressor 515 included a dog chasing and injuring a pig.

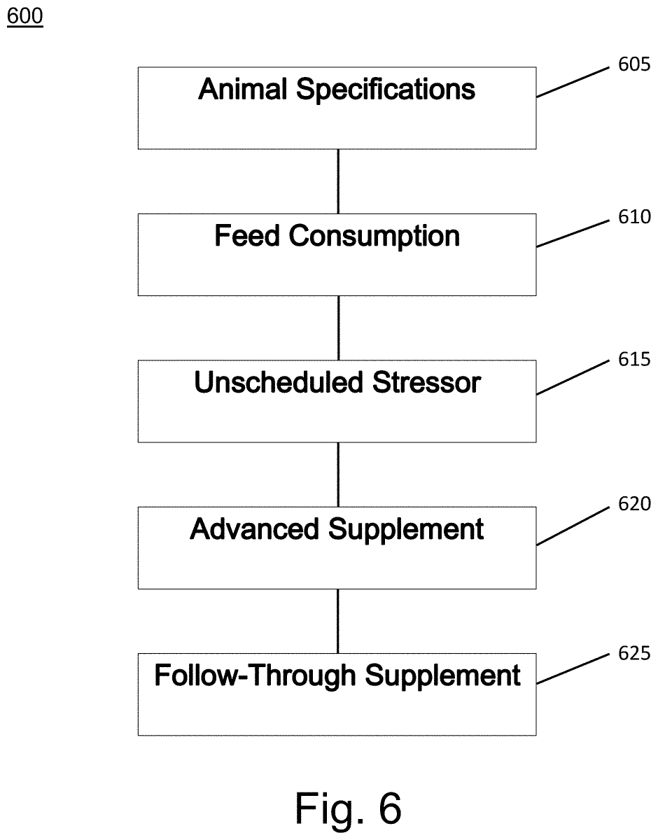

FIG. 6 illustrates an exemplary flowchart for method 600 of administering the nutritional supplement 200 to an animal through feed due to unscheduled stressor 615. Method 600 may be completed in any order and may include one or more steps in method 600 and may further be combined with one or more steps found in another method disclosed herein. Accordingly, the order provided is exemplary. Initially, an administrator may determine the animal specification 605. Each type of animal may have a different reaction to nutritional supplement 200. For example, cattle have a ruminant digestive system that includes a four-part stomach while pigs have a monogastric system that includes a single stomach. Each digestive system may absorb relaxant 105 differently and therefore it may be helpful to first determine the type of animal. Further, the type of breed may help determine the eating behavior of the animal and its propensity to absorb the nutritional supplement 200. Also, some animals are more selective in their diet than others. For example, a panda bear survives almost entirely on eating bamboo while a raccoon will eat almost any food found in a garbage can. As a result, a panda bear may need a substantial amount of bamboo-flavored palatability enhancer 115 while a raccoon may require very little palatability enhancer 115. Secondly, it may be helpful to determine the animals' age and weight to establish how much feed consumption 610 will occur. Also, concerning feed intake, it may be helpful to determine the surrounding environment because feed consumption 610 may be altered depending on how hot or cold the temperature is in the animal's environment.

Many of the animal specifications 605 determined in the previous step will then give the administrator an estimate of the amount of feed consumption 610 of the animal. Further indications of feed consumption 610 include the type of feed provided. Feed consumption 610 may be distinct if cattle are given mineral supplements as compared to sweet feed. Mineral supplements generally contain a selective amount of salt to help regulate animal feed consumption 610 and therefore fewer mineral supplements than sweet feed would be consumed by the cattle. As a result, tan amount or concentration of nutritional supplement 200 placed on sweet feed would be less than what was placed on mineral supplement because sweet feed is likely consumed at a higher rate than a mineral supplement. Stressors also have been known to affect feed consumption 610 and may be taken into consideration. Alternatively, if nutritional supplement 210 is being used to create a paste or a pill feed consumption 610 may be omitted.

The frequency and duration of unscheduled stressor 615 may be unknown. In one example, an unscheduled stressor may be a cow encountering a predator animal. Method 600 is intended to provide for the animal in different ways. First advanced supplement 620 may be given in preparation for an unknown stressor without a definite ending time (e.g, a wolf has been sighted in an area). Advance supplement 620 may be provided to the animal in preparation for an unscheduled stressor 615 and then followed by follow-through supplement 625 after the occurrence of unscheduled stressor 615 (e.g., a wolf attacks the animal at night and is later captured). The ratios of nutritional supplement 200 may be different for the advanced supplement 620 as compared to the follow-through supplement 625. In a second, embodiment advanced supplement 620 may be omitted and follow-through supplement 625 of nutritional supplement 200 may be provided after unscheduled stressor 615 occurs.

In practice, nutritional supplement 200 (as with nutritional supplement 100) may be administered with the amount of relaxant 105 being 1 mg per 1 kg of animal weight per day. The amount of relaxant 105 prescribed for an animal can range from 0.5 to 1.5 mg per 1 kg of animal weight per day. For example, animal specifications 605 may include a weaned pig weighing 24 kg. The pig weighing 24 kg may have a food consumption 610 of 1 kg of feed a day. The pig would require 1 mg of relaxant 105 per 1 kg of animal weight per day which would amount to 24 mg of relaxant 105. Palatability enhancer 115 can range 5.5% to 50% to the amount of relaxant 105. Assuming the pig is a selective eater 12 mg of a dry palatability enhancer 115 which is 50% of relaxant 105 in this example. There is generally a ratio of 1:3 of dry portion 205 to adhesive 210. The total dry portion 205 of nutritional supplement 200 would be 36 mg and at a 1:3 ratio of the amount of adhesive 210 would be 12 mg. The range of adhesive 210 may be between 5-25% of the nutritional supplement 200. The total amount of nutritional supplement 200 to be mixed with feed would be 48 mg per day for the 24 kg pig. Nutritional supplement 200 may be mixed manually or may be premixed using a machine and further may be machine mixed before packaging.

Advanced supplement 620 is set up to provide the nutritional supplement 200 at any time before unscheduled stressor 615. Optimally nutritional supplement 200 is provided to the animal two days to nine hours before unscheduled stressor 615. The impact of unscheduled stressor 615 can continue to affect the animal beyond the moment unscheduled stressor 615 occurred. To help alleviate the negative impact of unscheduled stressor 615 follow-through supplement 625 may be provided to the animal. Nutritional supplement 200 may allow the animal to resolve the negative impact of unscheduled stressor 615 more quickly. Follow-through supplement 625 may include nutritional supplement 200 given to the animal after unscheduled stressor 615 has occurred. A different combination of nutritional supplement 200 may be used for follow-through supplement 625 than was used for the advanced supplement 620. Ideally, nutritional supplement 200 would be provided to the animal for a duration of one to seven days after the unscheduled stressor 615. The duration of follow-through supplement 625 of nutritional supplement 200 may be adjusted depending on the type of unscheduled stressor 615. For example, if unscheduled stressor 615 included displacing a pig while cleaning out the pig pen because of an unexpected storm the duration of nutritional supplement 200 may be less than if the unscheduled stressor 615 included a dog chasing and injuring a pig.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims. Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. An animal nutritional supplement comprising:
relaxant; and
one or more palatability enhancers.

2. The animal nutritional supplement of claim 1 comprising:
an emulsifier.

3. The animal nutritional supplement of claim 2 wherein the relaxant comprises kavalactones.

4. The animal nutritional supplement of claim 2 wherein the relaxant comprises ashwagandha.

5. The animal nutritional supplement of claim 2 wherein the relaxant comprises ashwagandha and kavalactones.

6. The animal nutritional supplement of claim 2 wherein one of the one or more palatability enhancers includes dextrose.

7. The animal nutritional supplement of claim 2 wherein one of the one or more palatability enhancers includes fructose.

8. The animal nutritional supplement of claim 2 wherein one of the one or more palatability enhancers includes fructose and dextrose.

9. The animal nutritional supplement of claim 2 wherein the emulsifier to relaxant is at a 1:1 to a 1:4 ratio.

10. The animal nutritional supplement of claim 2 wherein the relaxant comprises 40 to 72 percent of the weight of the nutritional supplement.

11. The animal nutritional supplement of claim 2 wherein the one or more palatability enhancers comprise 4 to 20 percent of the weight of the nutritional supplement.

12. The animal nutritional supplement of claim 1 comprising:
an adhesive.

13. The animal nutritional supplement of claim 12 wherein the relaxant comprises kavalactones.

14. The animal nutritional supplement of claim 12 wherein the relaxant comprises ashwagandha.

15. The animal nutritional supplement of claim 12 wherein the relaxant comprises ashwagandha and kavalactones.

16. The animal nutritional supplement of claim 12 wherein one of the one or more palatability enhancers includes dextrose.

17. The animal nutritional supplement of claim 12 wherein one of the one or more palatability enhancers includes fructose.

18. The animal nutritional supplement of claim 12 wherein one of the one or more palatability enhancers includes fructose and dextrose.

19. The animal nutritional supplement of claim 12 wherein the adhesive to relaxant is at a 1:1 to a 1:4 ratio.

20. The animal nutritional supplement of claim 12 wherein the relaxant comprises 40 to 72 percent of the weight of the nutritional supplement.
